(19) United States
(12) Patent Application Publication
(10) Pub. No.: US 2021/0405157 A1
(43) Pub. Date: Dec. 30, 2021

(54) Alignment of Optical Transmitter with Multiple Degrees of Freedom

(71) Applicant: Waymo LLC, Mountain View, CA (US)

(72) Inventors: Blaise Gassend, East Palo Alto, CA (US); David Duff, Portola Valley, CA (US); Pierre-Yves Droz, Los Altos, CA (US)

(21) Appl. No.: 16/975,385

(22) PCT Filed: Mar. 4, 2020
(86) PCT No.: PCT/US20/20872

§ 371 Date: Aug. 24, 2020

Related U.S. Application Data
(60) Provisional application No. 62/814,164, filed on Mar. 5, 2019.

(51) Int. Cl. G01S 7/481; G01S 7/497; G01S 17/931

(52) U.S. Cl. CPC G01S 7/4812; G01S 17/931; G01S 7/4972

(57) ABSTRACT

The present disclosure relates to optical systems and methods of their manufacture. An example optical system includes a transmitter. The transmitter includes a reference axis and a light emitter device configured to emit light along a transmit path. The optical system also includes a rotatable mount configured to adjust an orientation of the light emitter device so as to adjust a pitch angle, a roll angle, or a yaw angle of the transmit path with respect to the reference axis. The optical system additionally includes a translatable mount configured to adjust a position of the light emitter device along a reference plane that is perpendicular to the reference axis.

### BACKGROUND

A conventional Light Detection and Ranging (LIDAR) system may utilize a light-emitting transmitter (e.g., a laser diode) to emit light pulses into an environment. Emitted light pulses that interact with (e.g., reflect from) objects in the environment can be received by a receiver (e.g., a photodetector) of the LIDAR system. Range information about the objects in the environment can be determined based on a time difference between an initial time when a light pulse is emitted and a subsequent time when the reflected light pulse is received.

### SUMMARY

The present disclosure generally relates to optical systems (e.g., LIDAR systems) and methods of their manufacture. Example embodiments include optical systems with mechanisms that may improve optical alignment between multiple components in the optical system.

In a first aspect, an optical system is provided. The optical system includes a transmitter. The transmitter includes a reference axis and a light emitter device configured to emit light along a transmit path. The transmitter also includes a rotatable mount configured to adjust an orientation of the light emitter device so as to adjust a pitch angle, a roll angle, or a yaw angle of the transmit path with respect to the reference axis. The transmitter also includes a translatable mount configured to adjust a position of the light emitter device along a reference plane that is perpendicular to the reference axis.

In a second aspect, a method of manufacture is provided. The method includes coupling a light emitter device to a printed circuit board. The light emitter device is oriented along a transmit path. The method also includes coupling the printed circuit board to a rotatable mount. The method yet further includes adjusting an orientation of the rotatable mount so as to adjust the transmit path with respect to a reference axis of a lens assembly. Adjusting the orientation of the rotatable mount includes adjusting a pitch angle, a roll angle, or a yaw angle of the transmit path with respect to the reference axis. The method further includes clamping the rotatable mount to the lens assembly by way of a clamp.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 illustrates an optical system, according to an example embodiment.

FIG. 2 illustrates an optical system, according to an example embodiment.

FIG. 3A illustrates an optical system, according to an example embodiment.

FIG. 3B illustrates an optical system, according to an example embodiment.

FIG. 4A illustrates a vehicle, according to an example embodiment.

FIG. 4B illustrates a vehicle, according to an example embodiment.

FIG. 4C illustrates a vehicle, according to an example embodiment.

FIG. 4D illustrates a vehicle, according to an example embodiment.

FIG. 4E illustrates a vehicle, according to an example embodiment.

FIG. 5 illustrates an optical system, according to an example embodiment.

FIG. 6 illustrates a method, according to an example embodiment.

FIG. 7A illustrates a portion of the method of FIG. 6, according to an example embodiment.

FIG. 7B illustrates a portion of the method of FIG. 6, according to an example embodiment.

FIG. 7C illustrates a portion of the method of FIG. 6, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

I. Overview

A LIDAR device includes a light transmitter configured to transmit light into an environment of the LIDAR device via one or more optical elements in a transmit path (e.g., a transmit lens, a mirror such as a rotating mirror, and an optical window) and a light detector configured to detect via one or more optical elements in a receive path (e.g., the optical window, the mirror, a receive lens, and a pinhole aperture) light that has been transmitted from the transmitter and reflected by an object in the environment. The light transmitter can be, for example, a laser die (e.g., made up of one or more laser diode bars) that emits light that diverges along a fast axis and a slow axis. The laser die can be optically coupled to a fast-axis collimating (FAC) lens (e.g., a cylindrical lens) that collimates the fast axis of the light emitted by the laser die to provide partially-collimated transmit light. The light detector can be, for example, a silicon photomultiplier (SiPM) that receives light through a pinhole aperture. With this arrangement, it is expected that the light transmitter and light detector are aligned relative to each other such that the light from the light transmitter can go through the transmit path into the environment of the LIDAR device and then be reflected by an object in the environment back into the LIDAR device and received by the detector through the receive path. If, however, the light transmitter and light detector are incorrectly aligned relative to each other, then the light from the light transmitter might not be in the proper direction to go through the transmit path, or the transmit light might go through the transmit path into the environment in a direction such that only a portion of the reflected light from an object in the environment can reach the detector or none at all.

To facilitate proper alignment, the light transmitter (laser die and FAC lens) can be mounted to an adjustment mechanism that allows for adjustment of multiple degrees of freedom of the light transmitter. In an example embodiment, the adjustment mechanism includes a spherical interface (with the light transmitter at the center) that allows for adjustment of the pitch, roll, and yaw angles, and a planar interface that allows for adjustment of the x and y positions of the light transmitter. The orientation and position of the light transmitter can be adjusted using the spherical and planar interfaces, respectfully, so that the light from the light transmitter reaches the light detector during operation of the LIDAR device.

II. Example Optical Systems

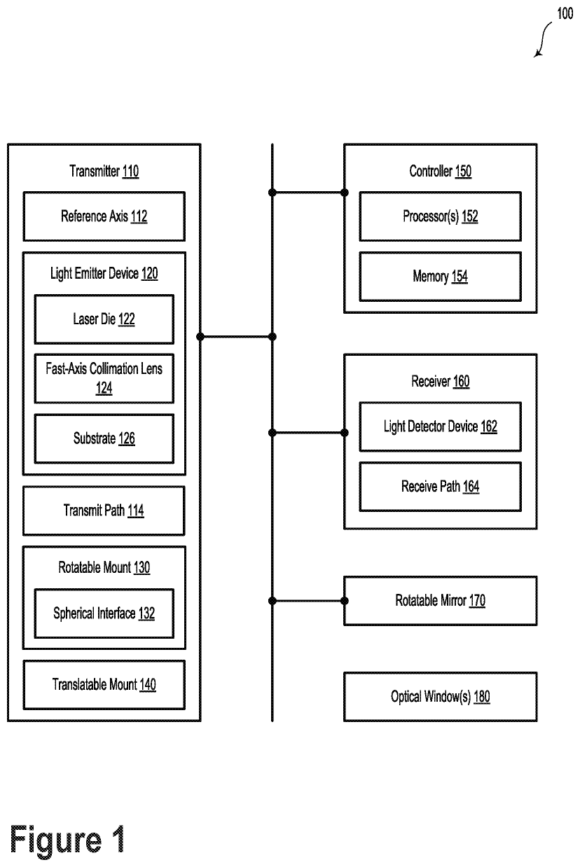

FIG. 1 illustrates an optical system 100, according to an example embodiment. In some examples, the optical system 100 could include a LIDAR system. As an example, the optical system 100 includes a transmitter 110. The transmitter 110 includes a reference axis 112. In some embodiments, the reference axis 112 may be defined by an optical lens set, a principal optical axis, an aperture, a final objective, a desired emission axis, or another axis.

The transmitter 110 includes a light emitter device 120. The light emitter device 120 could include a laser die 122 (e.g., a laser diode) and a fast-axis collimation (FAC) lens 124. The at least one laser die 122 could be configured to emit infrared light pulses. The FAC lens 124 is optically coupled to the at least one laser die 122. In some embodiments, the FAC lens 124 could include a cylindrical lens. However, other optical elements (e.g., an a cylindrical lens, a spherical lens, etc.) are contemplated and possible within the context of the present disclosure.

The light emitter device 120 could be disposed on a substrate 126. In some embodiments, the substrate 126 could include a printed circuit board, a laser die package, or another type of substrate. In an example embodiment, the substrate 126 could be formed of a ceramic material. Additionally or alternatively, the substrate 126 could include a glass-reinforced epoxy laminate material, such as FR-4. Other types of rigid substrate materials are possible and contemplated in the present disclosure.

The light emitter device 120 is configured to emit light along a transmit path 114. The transmit path 114 could be, for example, a principal emission axis of the laser die 122. In some embodiments, the transmit path 114 could be defined, at least in part, as being along an axis and/or parallel to a vector that extends substantially perpendicular from a facet of a laser bar of the laser die 122.

The transmitter 110 also includes a rotatable mount 130. The rotatable mount 130 could be configured to adjust an orientation of the light emitter device 120 so as to adjust a pitch angle, a roll angle, or a yaw angle of the transmit path 114 with respect to the reference axis 112. In such scenarios, the rotatable mount 130 could include a spherical interface 132. The spherical interface 132 could have a radius of curvature and a corresponding center of curvature. The light emitter device 120 is fixed to the rotatable mount 130 substantially at the center of curvature.

In some embodiments, the rotatable mount 130 is configured to provide a tip/tilt range of −5 to +5 degrees. Other angular adjustment ranges (e.g., −2 degrees to +2 degrees, −10 degrees to +10 degrees, etc.) are contemplated and possible within the scope of the present disclosure.

In some embodiments, the optical system 100 could include a translatable mount 140. In such scenarios, the translatable mount 140 could be configured to adjust a position of the light emitter device 120 along a reference plane that is perpendicular to the reference axis 112. In such scenarios, the translatable mount 140 is mechanically coupled to the rotatable mount 130. In some examples, adjusting a position of the light emitter device 120 includes adjusting the position of the light emitter device 120 along the reference plane so as to adjust an x-offset position or a y-offset position.

In some embodiments, the translatable mount 140 could be configured to provide an adjustment range of −1 to +1 mm in x and y. Other adjustment ranges (e.g., −10 mm to +10 mm) are contemplated and possible for the translatable mount 140 within the scope of the present disclosure.

In various embodiments, the optical system 100 also includes a receiver 160. The receiver 160 includes a light detector device 162 configured to receive light along a receive path 164.

In some embodiments, the light emitter device 120 could be mechanically fixed to the rotatable mount 130 and/or the translatable mount 140 with at least one of: an adhesive material (e.g., metal eutectic, glue, epoxy, or another material configured to bond elements together) or a plurality of fasteners. For example, in some embodiments, the light emitter device 120 could be fixed to the rotatable mount 130 by way of at least one spherical washer coupled to at least one fastener. The fasteners and/or the spherical washers could be formed of aluminum, steel, or another type of structural material. In other embodiments, the light emitter device 120 could be fixed to the rotatable mount 130 and/or the translatable mount 140 by way of a solder bond and/or a spot welding bond.

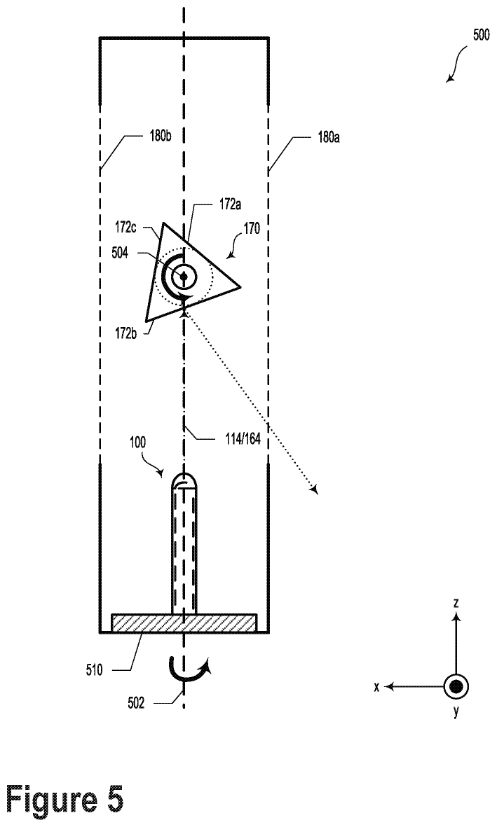

In example embodiments, the optical system 100 could include a rotatable mirror 170. In such scenarios, the light emitted along the transmit path 114 interacts with the rotatable mirror 170 so as to be reflected toward an environment of the optical system 100. In some embodiments, the optical system 100 could additionally or alternatively include a plurality of optical windows 180. The light reflected toward the environment of the optical system 100 is transmitted by way of at least one of the plurality of optical windows 180. The rotatable mirror 170 and optical windows 180 are further described in relation to FIG. 5.

In some examples, the optical system 100 also includes a controller 150. The controller 150 includes at least one of a field-programmable gate array (FPGA) or an application-specific integrated circuit (ASIC). Additionally or alternatively, the controller 150 may include one or more processors 152 and a memory 154. The one or more processors 152 may include a general-purpose processor or a special-purpose processor (e.g., digital signal processors, etc.). The one or more processors 152 may be configured to execute computer-readable program instructions that are stored in the memory 154. As such, the one or more processors 152 may execute the program instructions to provide at least some of the functionality and operations described herein.

The memory 154 may include or take the form of one or more computer-readable storage media that may be read or accessed by the one or more processors 152. The one or more computer-readable storage media can include volatile and/or non-volatile storage components, such as optical, magnetic, organic or other memory or disc storage, which may be integrated in whole or in part with at least one of the one or more processors 152. In some embodiments, the memory 154 may be implemented using a single physical device (e.g., one optical, magnetic, organic or other memory or disc storage unit), while in other embodiments, the memory 154 can be implemented using two or more physical devices.

As noted, the memory 154 may include computer-readable program instructions that relate to operations of optical system 100. As such, the memory 154 may include program instructions to perform or facilitate some or all of the functionality described herein. The controller 150 is configured to carry out operations. In some embodiments, controller 150 may carry out the operations by way of the processor 152 executing instructions stored in the memory 154.

The operations could include operating various elements of optical system 100 to obtain range information about an environment of the optical system 100. The controller 150 could be configured to carry out other operations as well.

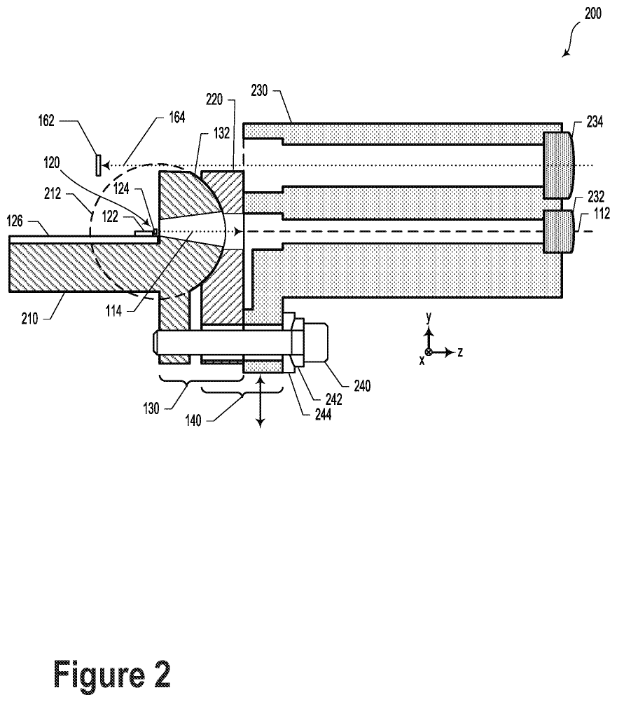

FIG. 2 illustrates an optical system 200, according to an example embodiment. The optical system 200 could include, for example, a rotational mount 130. The rotational mount 130 could include a ball portion 210 and a socket portion 220. The light emitter device 120 (laser die 122 and the FAC lens 124) could be mounted along a surface of the substrate 126. Furthermore, the substrate 126 could be mounted to a mounting surface of the ball portion 210. The laser die 122 and the FAC lens 124 could define a transmit path 114. The ball portion 210 could include at least one spherically-shaped convex surface that could make up an element of the spherical interface 132. The socket portion 220 could include a spherically-shaped concave surface that could make up another element of the spherical interface 132. In some embodiments, the spherical interface 132 may define, at least in part, a sphere 212.

While in contact with one another along the spherical interface, the ball portion 210 and the socket portion 220 could be configured to move in a rotationally-symmetric manner with respect to a center of curvature (e.g., a center of the sphere 212) of the spherical interface 132. In such scenarios, one or more portions of the light emitter device 120 could be arranged at the center of curvature of the spherical interface 132 such that movements of the ball portion 210 with respect to the socket portion 220 do not substantially change a relative position of the light emitting region of the laser die 122. Rather, movements of the ball portion 210 with respect to the socket portion 220 could result in changes in the angular orientation of light emission from the laser die 122. That is, moving the ball portion 210 with respect to the socket portion 220 could adjust an elevation angle (e.g., in rotation about the x axis), a roll angle (e.g., in rotation about the z axis), and/or a yaw or azimuthal angle (e.g., in rotation about they axis). In other words, the rotatable mount 130 could provide three degrees of freedom (DOF) (e.g., elevation/pitch, roll, yaw/azimuth) to adjust an angle of the transmit path 114 with respect to the light emitter device 120.

It will be understood that at least one of the ball portion 210 or the socket portion 220 could have other shapes. For example, the ball portion 210 and/or the socket portion 220 need not include a solid spherically-shaped surface. Rather, in some embodiments, the ball portion 210 and/or the socket portion 220 could include a plurality of contact points that are configured to interact with a spherically-shaped surface so as to provide a rotationally-symmetric movement of the ball portion 210 with respect to the socket portion 220.

It will be understood that other ball/socket arrangements are possible and contemplated. For example, a spherical ball portion could interact with a conically-shaped concave socket portion 220. Such an arrangement could provide good contact between parts even if the two surfaces are manufactured with a small scale factor relative to one another. Other interface shapes are contemplated and possible.

The optical system 200 could additionally include a lens assembly 230. The lens assembly 230 could include a transmit lens 232 and a receive lens 234. The transmit lens 232 and/or the lens assembly 230 could define the reference axis 112. For example, the reference axis 112 could correspond to the optical axis of the transmit lens 232. Additionally or alternatively, the receive lens 234 and/or the lens assembly 230 could define the receive path 164. As illustrated in FIG. 2, the socket portion 220 could abut the lens assembly 230 along one or more planes substantially perpendicular to the reference axis 112.

In some embodiments, the socket portion 220 and the lens assembly 230 could form the translational mount 140. In such scenarios, the socket portion 220 and the lens assembly 230 could be configured to move with respect to one another along a translation plane that could be parallel to the x-y plane. Accordingly, the translation mount 140 could provide an additional two DOF (e.g., x and y shift) to adjust a position of the light emitter device 120 with respect with other portions of the optical system 200, such as the lens assembly 230.

In example embodiments, various elements of optical system 200 (e.g., the ball portion 210, the socket portion 220, and the lens assembly 230) could be fixedly coupled to one another by way of a bolt 240 or another type of fastener. In some embodiments, the bolt may be screwed into a tapped portion of the ball portion 210. The socket portion 220 and/or the lens assembly 230 could include through holes with sufficient relief (e.g., clearance) to provide movement of the elements with respect to one another. The bolt 240 could fixedly couple to the lens assembly 230 by way of a spherical washer having a convex washer portion 242 and a concave washer portion 244. The spherical washer may provide for better retention of the lens assembly 230 surface with respect to the head of the bolt 240.

While FIG. 2 illustrates a particular configuration of various elements of optical system 200, it will be understood that such elements could be positioned and/or disposed differently with respect to one another. As an example, an orientation and corresponding coupling surfaces of bolt 240 could be reversed such that the head of the bolt 240 could be located proximate to the ball portion 210 of the optical system 200. In such a scenario, the bolt 240 could fixedly couple to the lens assembly 230 and the spherical washer could be disposed proximate to the ball portion 210. Such an arrangement could provide improved accessibility and/or serviceability. In such scenarios, the fastener axis can be maintained as stationary relative to the lens assembly 230 during alignment procedures. Other orientations and/or arrangements of elements of the optical system 200 are contemplated and possible.

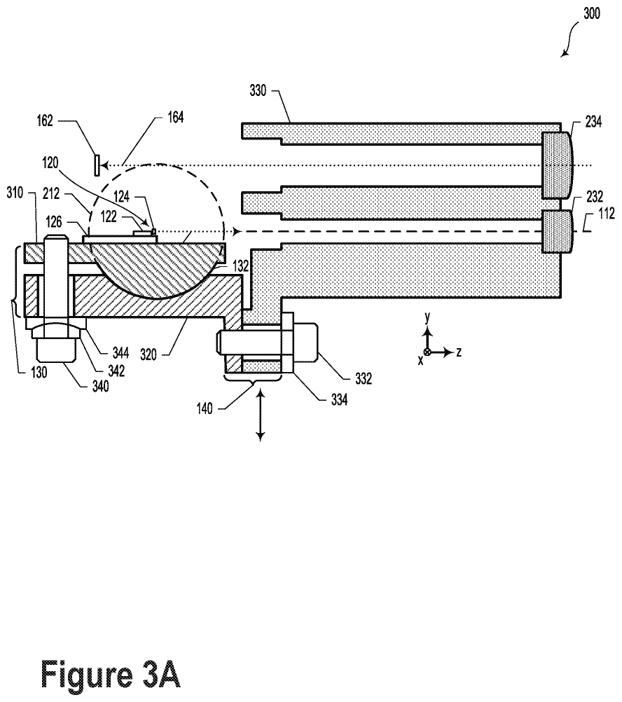

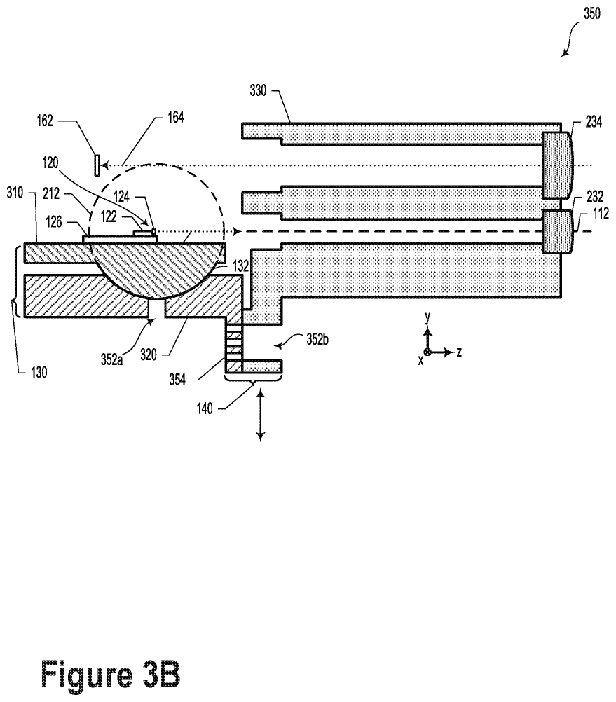

FIG. 3A illustrates an optical system 300, according to an example embodiment. Optical system 300 could include similar elements as optical systems 100 and 200 as illustrated and described in relation to FIGS. 1 and 2. However, in contrast to optical system 200, optical system 300 may include a different arrangement for the rotatable mount 130. Namely, as illustrated in FIG. 3A, the rotatable mount 130 could include a ball portion 310 with a convex spherically-symmetric shaped surface that could be disposed opposite the substrate 126. In other words, the spherically-shaped surface could be disposed opposite a mounting surface of the substrate 126. Furthermore, the socket portion 320 could be L-shaped. For example, the socket portion 320 could include a concave spherically-symmetric surface along a first side and a second surface along a second side that is configured to abut a portion of the lens assembly 330. In an example embodiment, the translatable mount 140 could include the interface between the second surface of the socket portion 320 and the lens assembly 330. In some embodiments, various components of optical system 300 could initially be fixed with respect to one another to “lock down” the angular degrees of freedom that need less accuracy. Thereafter, other adjustable components could be “fine-tuned” to one another. In such a fashion, complex optical alignment could be provided in a step-wise manner.

In some examples, the bolt 340 could be positioned in another location. For example, the bolt 340 could be disposed to screw directly into the ball portion 310. In such a scenarios, a single bolt 340 could be used to maintain a contact force between the ball portion 310 and the socket portion 320.

In some embodiments, the rotatable mount 130 (and its constituent ball portion 310 and socket portion 320) could be positionally fixed by way of a bolt 340, and a spherical washer having a convex washer portion 342 and a concave washer portion 344. Additionally or alternatively, the translatable mount 140 (and its constituent socket portion 320 and lens assembly 330) could be positionally fixed by way of a bolt 332 and a washer 334. In such scenarios, the light emitter device 120 could be positioned and fixed along an x-y plane in an independent manner with respect to adjustments provided by the rotatable mount 130. In other words, angular adjustments of a firing angle of the light emitter device 120 could be performed independently from translational adjustments.

By utilizing bolt 332 and bolt 340, a compressive force could be applied to the various elements of the optical system 300 (e.g., ball portion 310, socket portion 320, and lens assembly 330) so as to fix a position and orientation of the light emitter device 120 with respect to the lens assembly 330 and/or other portions of the optical system 300. However, other ways of applying a compressive force to the elements of optical system 300 are possible and are contemplated within the present disclosure. It will be understood that one or more bolts could be arranged differently in various embodiments. For example, a bolt could be positioned at an oblique angle with respect to the optical axis, which could fasten together the ball portion 310, the socket portion 320, and/or the lens assembly 330.

FIG. 3B illustrates an optical system 350, according to an example embodiment. Optical system 350 could be similar in some aspects to optical systems 100, 200, and 300, as illustrated and described in relation to FIGS. 1, 2, and 3A. In some embodiments, at least some elements of optical system 350 may be configured to be fixed by way of an adhesive, an epoxy, or another fixative material (e.g., a thermoset polymer). For example, the socket portion 320 could include an adhesive opening 352a configured to accept and contain a curable epoxy material. By filling the adhesive opening 352a with epoxy and then curing the epoxy, the ball portion 310 and the socket portion 320 could be positionally fixed with respect to one another. Additionally or alternatively, the socket portion 320 and/or the lens assembly 330 could provide an adhesive opening 352b, which could also accept and contain a curable epoxy material. Furthermore, in some embodiments, UV curing holes 354 could be provided so as to allow the epoxy material to be more easily and uniformly cured by allowing UV light into the adhesive opening 352b. In such scenarios, by inserting epoxy into the adhesive opening 352b and curing the epoxy via the UV curing holes 354, the cured epoxy can positionally fix the socket portion 320 with respect to the lens assembly 330.

FIG. 5 illustrates an optical system 500, according to an example embodiment. The optical system 500 could be similar to optical systems 100, 200, 300, and 350 as illustrated and described in reference to FIGS. 1, 2, 3A, and 3B. For example, optical system 500 could include optical system 100, which could be mounted to a rotatable stage 510. The rotatable stage 510 could be configured to rotate about an axis of rotation 502. In some embodiments, the rotatable stage 510 could be actuated by a stepper motor or another device configured to mechanically rotate the rotatable stage 510.

In some embodiments, the optical system 500 could include a rotatable mirror 170. The rotatable mirror 170 could be shaped like a triangular prism and could be configured to rotate about a mirror axis 504. The rotatable mirror 170 could include a plurality of reflective surfaces 172a, 172b, and 172c.

Additionally or alternatively, the optical system 500 could include optical windows 180a and 180b. The reflective surfaces 172a-c could be configured to reflect light pulses emitted by the optical system 100 along transmit path 114. For example, the light pulses could be reflected toward an environment of the optical system 500 by way of the optical windows 180a and 180b. Furthermore, reflected light pulses from the environment could be reflected from the reflective surfaces 172a-c along receive path 164.

In such a fashion, optical system 500 could be configured to emit light pulses into, and receive reflected light pulses from, a 360-degree region of the environment. Accordingly, the optical system 500 could be configured to determine range information based on the time-of-flight of the respective reflected light pulses.

III. Example Vehicles

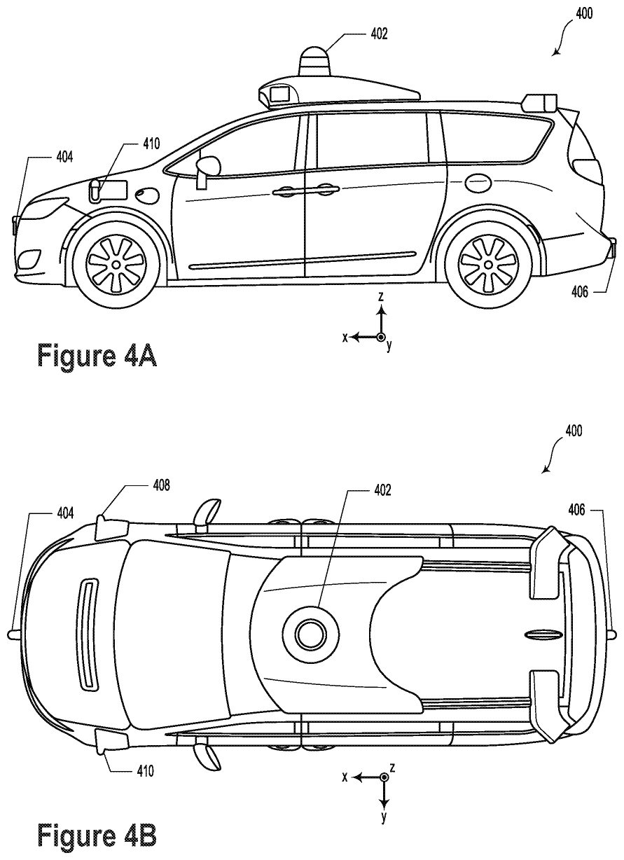

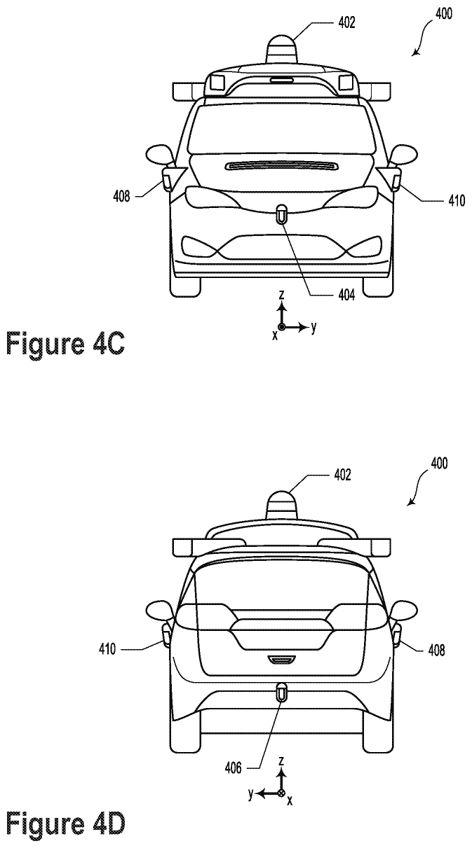

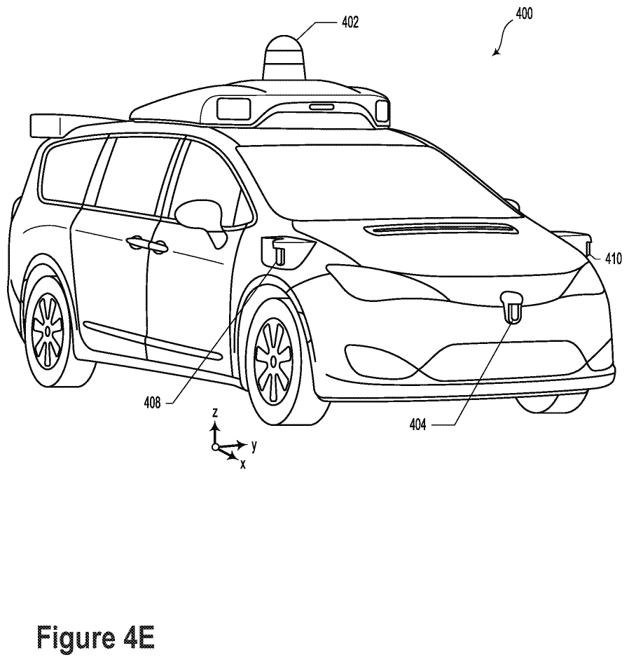

FIGS. 4A, 4B, 4C, 4D, and 4E illustrate a vehicle 400, according to an example embodiment. The vehicle 400 could be a semi- or fully-autonomous vehicle. While FIGS. 4A-4E illustrates vehicle 400 as being an automobile (e.g., a van), it will be understood that vehicle 400 could include another type of autonomous vehicle, robot, or drone that can navigate within its environment using sensors and other information about its environment.

The vehicle 400 may include one or more sensor systems 402, 404, 406, 408, and 410. Some embodiments, sensor systems 402, 404, 406, 408, and 410 could include LIDAR sensors having a plurality of light-emitter devices arranged over a range of angles with respect to a given plane (e.g., the x-y plane).

One or more of the sensor systems 402, 404, 406, 408, and 410 may be configured to rotate about an axis (e.g., the z-axis) perpendicular to the given plane so as to illuminate an environment around the vehicle 400 with light pulses. Based on detecting various aspects of reflected light pulses (e.g., the elapsed time of flight, polarization, intensity, etc.), information about the environment may be determined.

In an example embodiment, sensor systems 402, 404, 406, 408, and 410 may be configured to provide respective point cloud information that may relate to physical objects within the environment of the vehicle 400. While vehicle 400 and sensor systems 402, 404, 406, 408, and 410 are illustrated as including certain features, it will be understood that other types of sensor systems are contemplated within the scope of the present disclosure.

An example embodiment may include a system having a plurality of light-emitter devices. The system may include a transmit block of a LIDAR device. For example, the system may be, or may be part of, a LIDAR device of a vehicle (e.g., a car, a truck, a motorcycle, a golf cart, an aerial vehicle, a boat, etc.). Each light-emitter device of the plurality of light-emitter devices is configured to emit light pulses along a respective beam elevation angle. The respective beam elevation angles could be based on a reference angle or reference plane, as described elsewhere herein. In some embodiments, the reference plane may be based on an axis of motion of the vehicle 400.

While LIDAR systems with multiple light-emitter devices are described and illustrated herein, LIDAR systems with fewer light-emitter devices (e.g., a single light-emitter device) are also contemplated. For example, light pulses emitted by a laser diode may be controllably directed about an environment of the system. The angle of emission of the light pulses may be adjusted by a scanning device such as, for instance, a mechanical scanning mirror and/or a rotational motor. For example, the scanning devices could rotate in a reciprocating motion about a given axis and/or rotate about a vertical axis. In another embodiment, the light-emitter device may emit light pulses towards a spinning prism mirror, which may cause the light pulses to be emitted into the environment based on an angle of the prism mirror angle when interacting with each light pulse. Additionally or alternatively, scanning optics and/or other types of electro-opto-mechanical devices are possible to scan the light pulses about the environment.

In some embodiments, a single light-emitter device may emit light pulses according to a variable shot schedule and/or with variable power per shot, as described herein. That is, emission power and/or timing of each laser pulse or shot may be based on a respective elevation angle of the shot. Furthermore, the variable shot schedule could be based on providing a desired vertical spacing at a given distance from the LIDAR system or from a surface (e.g., a front bumper) of a given vehicle supporting the LIDAR system. As an example, when the light pulses from the light-emitter device are directed downwards, the power-per-shot could be decreased due to a shorter anticipated maximum distance to target. Conversely, light pulses emitted by the light-emitter device at an elevation angle above a reference plane may have a relatively higher power-per-shot so as to provide sufficient signal-to-noise to adequately detect pulses that travel longer distances.

In some embodiments, the power/energy-per-shot could be controlled for each shot in a dynamic fashion. In other embodiments, the power/energy-per-shot could be controlled for successive set of several pulses (e.g., 10 light pulses). That is, the characteristics of the light pulse train could be changed on a per-pulse basis and/or a per-several-pulse basis.

While FIG. 4 illustrates various LIDAR sensors attached to the vehicle 400, it will be understood that the vehicle 400 could incorporate other types of sensors, such as a plurality of optical systems, as described below.

IV. Example Methods of Manufacture

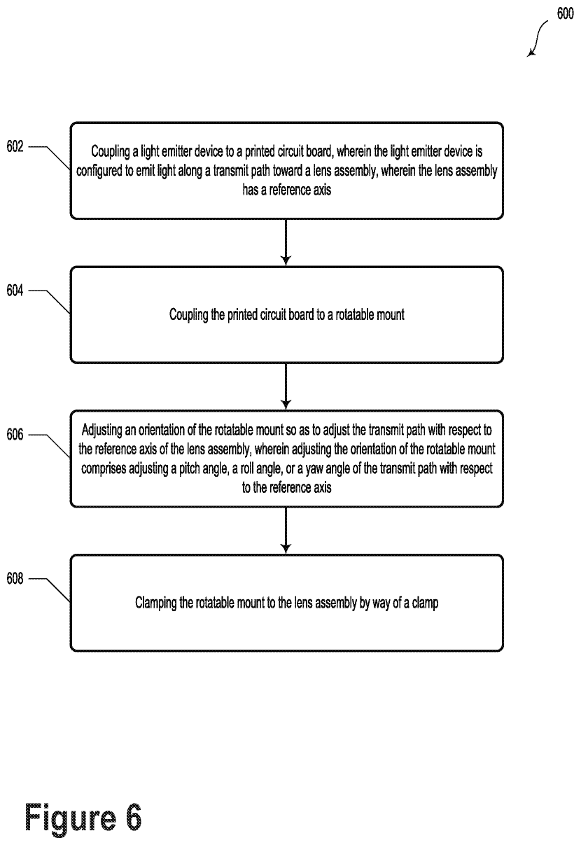

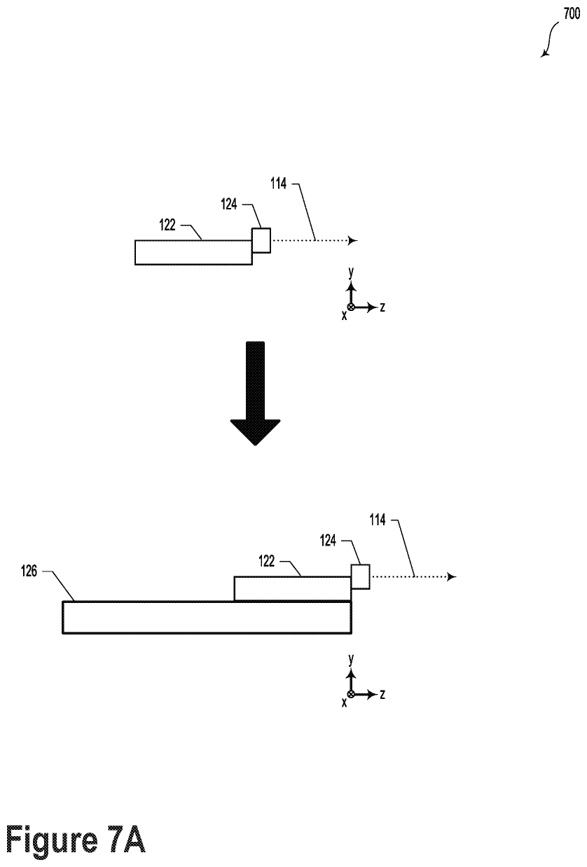

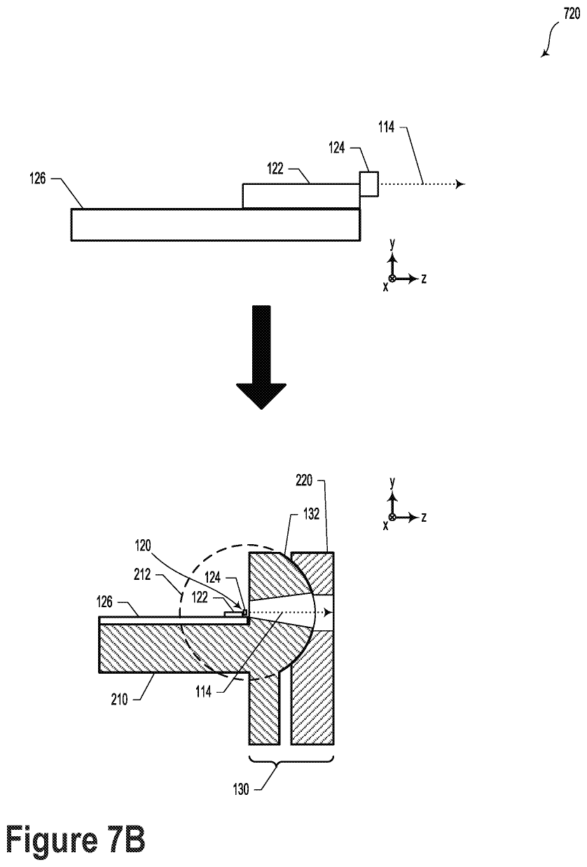

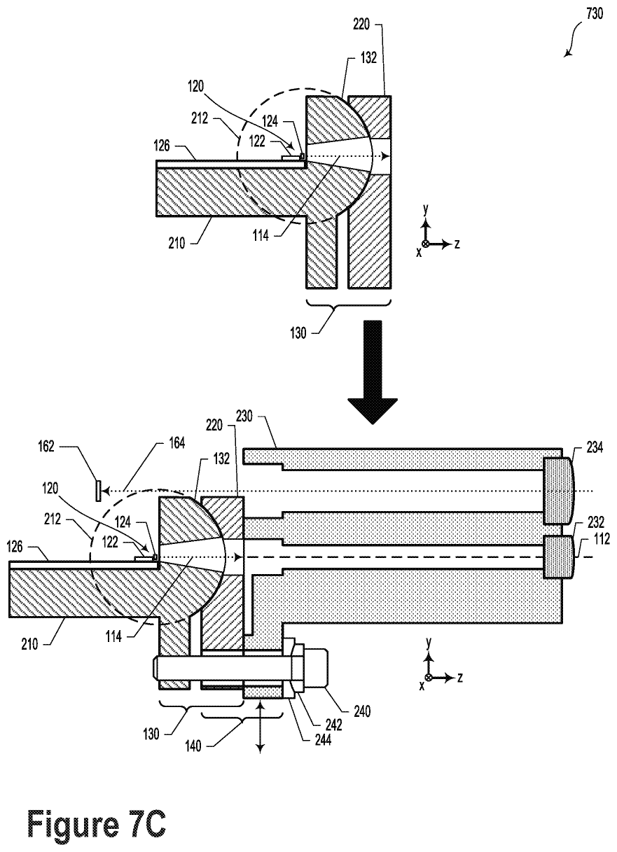

FIG. 6 illustrates a method 600, according to an example embodiment. FIGS. 7A, 7B, and 7C illustrate one or more portions of the method 600 of FIG. 6, according to an example embodiment. It will be understood that the method 600 may include fewer or more steps or blocks than those expressly illustrated or otherwise disclosed herein. Furthermore, respective steps or blocks of method 600 may be performed in any order and each step or block may be performed one or more times. In some embodiments, some or all of the blocks or steps of method 600 may relate to elements of optical systems 100, 200, 300, or 350 and/or vehicle 400 as illustrated and described in relation to FIGS. 1, 2, 3A, 3B, 4A, 4B, 4C, 4D, and 4E.

Block 602 includes coupling a light emitter device (e.g., light emitter device 120) to a printed circuit board (e.g., substrate 126). Coupling the light emitter device to the printed circuit board could include bonding the light emitter device to the printed circuit board. In some embodiments, the printed circuit board could include some or all of a laser driver circuit. In such scenarios, the light emitter device could be wire bonded to conductive pads the printed circuit board so as to electrically connect the light emitter device to the laser driver circuit.

In some embodiments, the light emitter device could be configured to emit light along a transmit path toward a lens assembly. In such scenarios, one or more lenses of the lens assembly could define a reference axis (e.g., reference axis 112). In some examples, the transmit path could be substantially perpendicular to a laser bar facet surface. Method 600 could additionally include optically coupling a fast-axis collimation (FAC) lens to the light emitter device. The FAC lens could include, for example, a cylindrical lens.

In reference to FIG. 7A, scenario 700 includes a laser die 122 and FAC lens 124 that define a transmit path 114. The transmit path 114 could include, for example, a principle axis of light emission from the laser die 122. The laser die 122 could be coupled (e.g., bonded) to a substrate 126, which could include a printed circuit board.

Block 604 includes coupling the printed circuit board to a rotatable mount. In some embodiments, coupling the printed circuit board to the rotatable mount could include fixing the printed circuit board with an epoxy or another type of adhesive. Additionally or alternatively, the printed circuit board could be coupled or fastened to the rotatable mount with one or more fasteners (e.g., bolts, screws, clamps, staples, etc.). The rotatable mount could include a spherical interface with a radius of curvature and a corresponding center of curvature.

In some examples, method 600 could include adjusting a position of the light emitter device with respect to the rotatable mount such that the light emitter device is disposed substantially at the center of curvature.

For example, in reference to FIG. 7B, scenario 720 includes coupling the substrate 126 to a rotatable mount 130, which could include a ball portion 210 and a socket portion 220. The spherical interface 132 may define a sphere 212. In some embodiments, the light emitter device 120 could be arranged at a center of curvature (e.g., the center of sphere 212) of one or more spherical interfaces 132 between the ball portion 210 and the socket portion 220.

Block 606 includes adjusting an orientation of the rotatable mount so as to adjust the transmit path with respect to the reference axis of the lens assembly. In some embodiments, adjusting the orientation of the rotatable mount could include adjusting a pitch angle, a roll angle, or a yaw angle of the transmit path with respect to the reference axis.

In some embodiments, the rotatable mount could be adjusted within a tip/tilt range of −5 to +5 degrees. In other words, using the rotatable mount, the transmit path could be adjusted in pitch/elevation, roll, and yaw/azimuth angle with respect to the reference axis.

Block 608 includes clamping the rotatable mount to the lens assembly by way of a clamp. Such a clamp could include, for example, an adhesive bond, a solder bond, a weld bond, etc.

By way of example, in reference to FIG. 7C, scenario 730 includes fixing the rotatable mount 130 to the lens assembly 230 with a bolt 240. It will be understood that more fasteners could be used (e.g., three bolts). In some embodiments, method 600 may additionally or alternatively include mechanically fixing the rotatable mount 130 to the lens assembly 230 by way of at least one of: an epoxy material or a plurality of fasteners. For example, an adhesive (e.g., a curable epoxy) could be utilized to fix the rotatable mount 130 to the lens assembly 230.

In example embodiments, the method 600 could include adjusting a position of a translatable mount so as to adjust a position of the light emitter device along a reference plane that is perpendicular to the reference axis. In other words, adjusting the position of the translatable mount could include adjusting an x-offset position or a y-offset position of the light emitter device. For example, again in reference to FIG. 7C, the translatable mount 140 could be adjusted so as to move the light emitter device 120 with respect to the lens assembly 230 along the x-y plane.

In some embodiments, method 600 includes coupling a receiver to the lens assembly. In such scenarios, the receiver could include, for example, a light detector device 162 configured to receive light along a receive path 164.

In example embodiments, method 600 could include causing the light emitter device to emit a light pulse. Causing the light emitter device to emit a light pulse could include triggering a laser pulser circuit with a controller (e.g., controller 150).

Method 600 may additionally or alternatively include receiving at least a portion of the light pulse from a receiver by way of a receive path (e.g., receive path 164). In such scenarios, the method 600 could also include aligning the transmit path to the receive path by adjusting the orientation of the rotatable mount (and/or a position of the translatable mount) so as to maximize the portion of the light pulse received.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

The specification includes the following subject-matter, expressed in the form of clauses 1-20: 1. An optical system comprising: a transmitter comprising: a reference axis; a light emitter device configured to emit light along a transmit path; a rotatable mount configured to adjust an orientation of the light emitter device so as to adjust a pitch angle, a roll angle, or a yaw angle of the transmit path with respect to the reference axis; and a translatable mount configured to adjust a position of the light emitter device along a reference plane that is perpendicular to the reference axis. 2. The optical system of clause 1, further comprising: a receiver comprising: a light detector device configured to receive light along a receive path. 3. The optical system of clause 1 or 2, wherein the light emitter device comprises: at least one laser die configured to emit infrared light pulses; and a fast-axis collimation lens optically coupled to the at least one laser die. 4. The optical system of clause 3, wherein the fast-axis collimation lens comprises a cylindrical lens. 5. The optical system of any of clauses 1-4, wherein the rotatable mount comprises a spherical interface with a radius of curvature and a corresponding center of curvature, wherein the light emitter device is fixed to the rotatable mount substantially at the center of curvature. 6. The optical system of any of clauses 1-5, wherein the translatable mount is mechanically coupled to the rotatable mount, wherein adjusting a position of the light emitter device comprises adjusting the position of the light emitter device along the reference plane so as to adjust an x-offset position or a y-offset position. 7. The optical system of any of clauses 1-6, wherein the light emitter device is mechanically fixed to the rotatable mount and the translatable mount with at least one of: an adhesive material or a plurality of fasteners. 8. The optical system of clause 7, further comprising: at least one spherical washer coupled to at least one fastener. 9. The optical system of any of clauses 1-8, further comprising: a rotatable mirror, wherein the light emitted along the transmit path interacts with the rotatable mirror so as to be reflected toward an environment of the optical system. 10. The optical system of any of clauses 1-9, further comprising: a plurality of optical windows, wherein light reflected toward the environment of the optical system is transmitted by way of at least one of the plurality of optical windows. 11. A method of manufacture, comprising: coupling a light emitter device to a printed circuit board, wherein the light emitter device is configured to emit light along a transmit path toward a lens assembly, wherein the lens assembly has a reference axis; coupling the printed circuit board to a rotatable mount; adjusting an orientation of the rotatable mount so as to adjust the transmit path with respect to the reference axis of the lens assembly, wherein adjusting the orientation of the rotatable mount comprises adjusting a pitch angle, a roll angle, or a yaw angle of the transmit path with respect to the reference axis; and clamping the rotatable mount to the lens assembly by way of a clamp. 12. The method of manufacture of clause 11, wherein the rotatable mount comprises a spherical interface with a radius of curvature and a corresponding center of curvature. 13. The method of manufacture of clause 12, further comprising: adjusting a position of the light emitter device with respect to the rotatable mount such that the light emitter device is disposed substantially at the center of curvature. 14. The method of manufacture of any of clauses 11-13, further comprising: adjusting a position of a translatable mount so as to adjust a position of the light emitter device along a reference plane that is perpendicular to the reference axis. 15. The method of manufacture of clause 14, wherein adjusting the position of the translatable mount comprises adjusting an x-offset position or a y-offset position of the light emitter device. 16. The method of manufacture of any of clauses 11-15, further comprising: mechanically fixing the rotatable mount to the lens assembly by way of at least one of: an adhesive material or a plurality of fasteners. 17. The method of manufacture of any of clauses 11-16, further comprising: coupling a receiver to the lens assembly, wherein the receiver comprises a light detector device configured to receive light along a receive path. 18. The method of manufacture of any of clauses 11-17, further comprising: optically coupling a fast-axis collimation lens to the light emitter device wherein the fast-axis collimation lens comprises a cylindrical lens. 19. The method of manufacture of any of clauses 11-18, wherein the rotatable mount is configured to provide a tip/tilt range of at least −2 to +2 degrees. 20. The method of manufacture of any of clauses 11-19, further comprising: causing the light emitter device to emit a light pulse; receiving at least a portion of the light pulse from a receiver by way of a receive path; and aligning the transmit path to the receive path by adjusting the orientation of the rotatable mount so as to maximize the portion of the light pulse received.

What is claimed is:

1. An optical system comprising:
a transmitter comprising:
a reference axis;
a light emitter device configured to emit light along a transmit path;
a rotatable mount configured to adjust an orientation of the light emitter device so as to adjust a pitch angle, a roll angle, or a yaw angle of the transmit path with respect to the reference axis; and
a translatable mount configured to adjust a position of the light emitter device along a reference plane that is perpendicular to the reference axis.

2. The optical system of claim 1, further comprising:
a receiver comprising:
a light detector device configured to receive light along a receive path.

3. The optical system of claim 1, wherein the light emitter device comprises:
at least one laser die configured to emit infrared light pulses; and
a fast-axis collimation lens optically coupled to the at least one laser die.

4. The optical system of claim 3, wherein the fast-axis collimation lens comprises a cylindrical lens.

5. The optical system of claim 1, wherein the rotatable mount comprises a spherical interface with a radius of curvature and a corresponding center of curvature, wherein the light emitter device is fixed to the rotatable mount substantially at the center of curvature.

6. The optical system of claim 5, wherein the translatable mount is mechanically coupled to the rotatable mount, wherein adjusting a position of the light emitter device comprises adjusting the position of the light emitter device along the reference plane so as to adjust an x-offset position or a y-offset position.

7. The optical system of claim 1, wherein the light emitter device is mechanically fixed to the rotatable mount and the translatable mount with at least one of: an adhesive material or a plurality of fasteners.

8. The optical system of claim 7, further comprising:
at least one spherical washer coupled to at least one fastener.

9. The optical system of claim 1, further comprising:
a rotatable mirror, wherein the light emitted along the transmit path interacts with the rotatable mirror so as to be reflected toward an environment of the optical system.

10. The optical system of claim 9, further comprising:
a plurality of optical windows, wherein the light reflected toward the environment of the optical system is transmitted by way of at least one of the plurality of optical windows.

11. A method of manufacture, comprising:
coupling a light emitter device to a printed circuit board, wherein the light emitter device is configured to emit light along a transmit path toward a lens assembly, wherein the lens assembly has a reference axis;
coupling the printed circuit board to a rotatable mount;
adjusting an orientation of the rotatable mount so as to adjust the transmit path with respect to the reference axis of the lens assembly, wherein adjusting the orientation of the rotatable mount comprises adjusting a pitch angle, a roll angle, or a yaw angle of the transmit path with respect to the reference axis; and
clamping the rotatable mount to the lens assembly by way of a clamp.

12. The method of manufacture of claim 11, wherein the rotatable mount comprises a spherical interface with a radius of curvature and a corresponding center of curvature.

13. The method of manufacture of claim 12, further comprising:
adjusting a position of the light emitter device with respect to the rotatable mount such that the light emitter device is disposed substantially at the center of curvature.

14. The method of manufacture of claim 11, further comprising:
adjusting a position of a translatable mount so as to adjust a position of the light emitter device along a reference plane that is perpendicular to the reference axis.

15. The method of manufacture of claim 14, wherein adjusting the position of the translatable mount comprises adjusting an x-offset position or a y-offset position of the light emitter device.

16. The method of manufacture of claim 11, further comprising:
mechanically fixing the rotatable mount to the lens assembly by way of at least one of: an adhesive material or a plurality of fasteners.

17. The method of manufacture of claim 11, further comprising:
coupling a receiver to the lens assembly, wherein the receiver comprises a light detector device configured to receive light along a receive path.

18. The method of manufacture of claim 11, further comprising:
optically coupling a fast-axis collimation lens to the light emitter device wherein the fast-axis collimation lens comprises a cylindrical lens.

19. The method of manufacture of claim 11, wherein the rotatable mount is configured to provide a tip/tilt range of at least −2 to +2 degrees.

20. The method of manufacture of claim 11, further comprising:
causing the light emitter device to emit a light pulse;
receiving at least a portion of the light pulse from a receiver by way of a receive path; and
aligning the transmit path to the receive path by adjusting the orientation of the rotatable mount so as to maximize the portion of the light pulse received.
